(19) United States
(12) Patent Application Publication
(10) Pub. No.: US 2011/0028252 A1
(43) Pub. Date: Feb. 3, 2011

(54) UNIVERSAL SKIP-FREE DERAILLEUR

(76) Inventor: Tzvetan Nedialkov Tzvetkov, Powhatan, VA (US)

Correspondence Address: TZVETAN NEDIALKOV TZVETKOV, 1928 PINE CREEK BLUFF ROAD, POWHATAN, VA, 23139, US

(21) Appl. No.: 12/533,634

(22) Filed: Jul. 31, 2009

(51) Int. Cl. B62M 9/12; F16H 59/02

(52) U.S. Cl. 474/80

(57) ABSTRACT

The invention is a universal front and rear derailleur configured to work with a variable mechanical transmission of the chain and sprocket type. A hollow axle is mounted adjacent to the sprockets. At least one radial arm serving as a chain lifter is rotatably mounted on the hollow axle in the chain-free sector of the sprockets. An operator controlled mechanism forces the lifter to move axially against a spring towards the sprockets. Upon contact, the sprockets entrain the lifter under the chain. The chain is lifted from the active sprocket and deposited onto another sprocket. Completing a full circle, the lifter is pushed back by the spring in its stowing position.

### BACKGROUND OF THE INVENTION

1. Field of the Invention

This invention relates generally to bicycle derailleurs. More specifically, this invention relates to a derailleur design, which is universally suited for the front, driving chain ring assembly as well as for the rear, driven sprocket assembly.

2. Description of Related Art

Conventional bicycle front derailleurs typically use an axially movable cage to force the chain against the adjacent larger sprocket when an up shift is initiated. The combination of rotation and friction eventually forces the chain to climb the larger sprocket and engage the teeth. Conversely, axial pressure by the cage forces the chain to derail from the larger sprocket and drop on the smaller sprocket. Since these movements of the chain occur in the loaded section of the chain, the rider has to reduce the pedaling force in order to allow the chain to climb the side of the larger sprocket, as friction is not sufficient to overcome the downward pressure of the tensioned chain. Similarly, when the chain derails from a larger to a smaller sprocket, the rider has to reduce the pedaling force, or the chain will slam on the smaller sprocket. Although the problem is not so acute for the rear sprocket assembly as the shifting initiates in the unloaded section of the chain, it is nevertheless present and has not been resolved in a definitive way.

Various approaches have been tried to resolve this issue. The prevailing approach has been to form pins or ramps on the sides of the chain rings and sprockets. One such example can be seen in U.S. Pat. No. 5,078,653, where a combination of pins and reduced teeth facilitate the derailing of the chain from a larger to a smaller sprocket. A similar solution is proposed in U.S. Pat. No. 5,738,603 and claims to facilitate both up shifts and downshifts. While the implementation of such chain shift facilitating means has been proved helpful, they usually are a compromise, where either the up shift or downshift is improved, but not both. It needs to be said that this approach is more successful when applied to a multiple sprocket rear assemblies, where a smaller difference in the diameter of the adjacent sprocket results in a smoother shifting. This, however, has resulted in unnecessarily large sprocket assemblies.

U.S. Pat. No. 5,205,794 describes a shifting mechanism, which is a radical departure from traditional derailleurs. A sector of the sprocket cluster is hinged and allows the chain to change tracks like a train on a railway switch. While the idea behind this invention is promising, the resulting complexity and likely elevated production cost of the system makes it an unlikely winner in the marketplace.

A much earlier invention shown in FIG. 1—U.K. patent No. 9192 of 1901 issued to Edmund Hodgkinson, describes a derailleur where the sprocket cluster is axially movable when a pair of chain lifters is engaged. The operator moves the chain lifters via a lever between the chain and active sprocket and then backpedals, fully lifting and disengaging the chain. After sliding the desired sprocket under the chain, he pedals forward retracting the chain lifters in the rest position. While revolutionary for the time, few cyclists would accept such mode of operation today.

For the foregoing reasons, there is a need for a universal chain shifting device that: (i) can shift under full load without skipping, (ii) will not create friction, (iii) can support a reduced number of sprockets with a large span of diameters (iv) will not require adjustment, (v) will allow for a greater clearance from the ground, (vi) will be less prone to damage, (vii) is less complex than mainstream derailleurs and (viii) is better suited for mass production and hence is relatively inexpensive to produce.

### SUMMARY OF THE INVENTION

The present invention is a universal front and rear derailleur, which has chain lifters mounted coaxially with the sprockets and which interpose between the sprockets and the chain rotating 360° in tandem with the sprocket assembly when engaged. The result of this motion is that the chain is lifted from one sprocket and deposited onto another sprocket without scraping and skipping. A special mechanism moves the chain lifters selectively and axially from a stow position in the chain-free sector and forces them to be entrained by the sprockets under the chain. Upon completion of a full circle the chain lifters are forced by springs to return axially in the initial stow position.

In one embodiment of the proposed invention the first, up shifting chain lifter is formed as a sector of a cone with chain guiding teeth leading from larger to smaller sprockets. The second, downshifting chain lifter is also formed as a sector of a cone with chain guiding teeth leading from smaller to larger sprockets.

In another embodiment of the proposed invention, both chain lifters are L-shaped radial arms with spring biased collapsible parallelogram bridges at the ends. The upper surfaces of the parallelograms have slots engaging the chain and shifting it sideways. The up shifting occurs when the up-shift chain lifter is engaged and its parallelogram collapses under chain pressure from a larger towards a smaller sprocket. The downshifting occurs when the downshift chain lifter is engaged and its parallelogram collapses under chain pressure from a smaller towards a larger sprocket.

The proposed invention is compatible with existing bicycle designs and can be fitted to frames and sprocket assemblies in current production as well as to be retrofitted to existing bicycles. The requirement to the shift control unit is simple: the cable has to be spring biased at the handlebar control in one position so it can be paid out by compressing this spring or retracted in the other direction against a weaker spring on the derailleur. In the first case an up-shift is initiated, in the second, a downshift. Both are completed in one full turn and continue until the shifter is released. Shifting can occur either in forward pedaling or pedaling backwards. The assembly is mounted on the rear wheel axle for a rear derailleur and on the bicycle bottom bracket shell for a front derailleur. Since the chain moving elements rotate with the sprockets/chain rings, no adjustments are required like in the traditional derailleurs that have chain moving elements attached to the bicycle frame.

These and other features and advantages of the present invention will be more fully understood from the following description of one or more embodiments of the invention, taken together with the accompanying drawings.

### BRIEF DESCRIPTION OF THE DRAWINGS

FIG. 1 is a prior art drawing illustrating a derailleur with chain lifters.

FIG. 2 is a perspective view of a first embodiment of a rear derailleur shown in the process of up shifting.

FIG. 3 is a perspective view of the same embodiment shown in the process of downshifting.

FIG. 4 is an exploded view of the constituent parts of this particular embodiment.

FIG. 5 is a perspective view of an alternative embodiment of a rear derailleur shown in the process of up shifting.

FIG. 6 is a perspective view of the alternative embodiment shown in the process of downshifting.

FIG. 7 is an exploded view of the constituent parts of the alternative embodiment.

FIG. 8 is a close-up perspective view of the stacked parallelogram bridges of the alternative embodiment.

FIG. 9 is a close-up perspective view of the alternative embodiment in the process of downshifting.

FIG. 10 is an exploded view of the actuator mechanism common to both embodiments.

FIG. 11 is a perspective view of the fully assembled actuator mechanism.

FIG. 12 is a general view of the first embodiment as a front derailleur.

FIG. 13 is a general view of the alternative embodiment as a front derailleur.

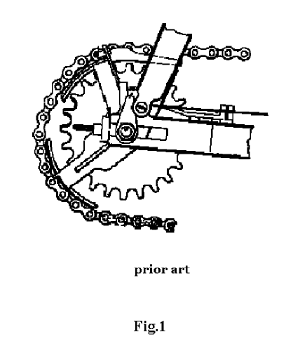

### DETAILED DESCRIPTION OF THE INVENTION

The described invention includes 2 embodiments, which do not limit its scope. Both embodiments can be designed to be used as front or rear derailleurs.
In order to avoid unnecessary duplication of description, only the construction and function of a rear derailleur is presented.
The front derailleur version differs only in size and attachment location. The same design of the actuator mechanism is common for both embodiments.
A simple 3-sprocket set is shown for clarity. Both embodiments can incorporate any number of sprockets.
Whenever the term downshifting for a rear derailleur is used, it should be understood that the chain is being transferred from a smaller to a larger sprocket. Conversely, up shifting refers to the chain being transferred from a larger to a smaller sprocket. It should be understood, that this order is inverted for a front derailleur.
Two elements of the complete system are described marginally, as they are not claimed—the chain tensioner and the shift controller.

FIG. 4 illustrates the detailed construction of the first preferred embodiment. Typically the rear bicycle wheel rotates on an axle 38 fixedly attached to the frame (not shown). The hub containing the bearings also carries the freewheel and the sprockets B. Locknuts hold the hub in place axially. Locknut 40 on the sprocket side serves as the stop for the hollow axle 41, which is held tight in place by another nut 45 recessed in the axle pit. The following components are assembled in order on said hollow axle 41: diaphragm spring 46, up shifting lifter 47, diaphragm spring 53, downshifting lifter 54, fixed depressor plate A2, rotating depressor plate A1. When inactive, lifters 47 and 54 are held away from the sprocket assembly B by spring 46.

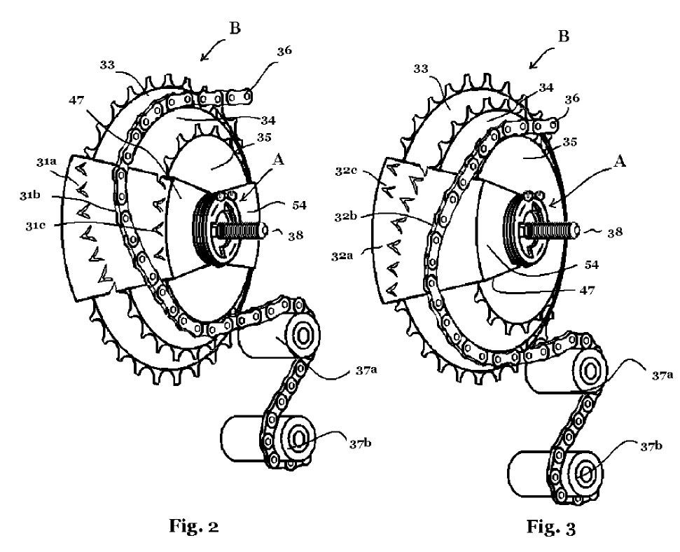

When initiating an up shift, the actuator A pushes only lifter 47 towards sprocket 39, compressing spring 46, where a ridge 52 catches on a protrusion 39. Since spring 53 holds lifter 54 in a distal, inactive position, only lifter 52 rotates with the sprocket assembly B. Going to FIG. 2, it can be seen how the chain 36 is guided by the row of teeth 31b from the medium sprocket 34 to the smallest sprocket 39 effecting an up shift.

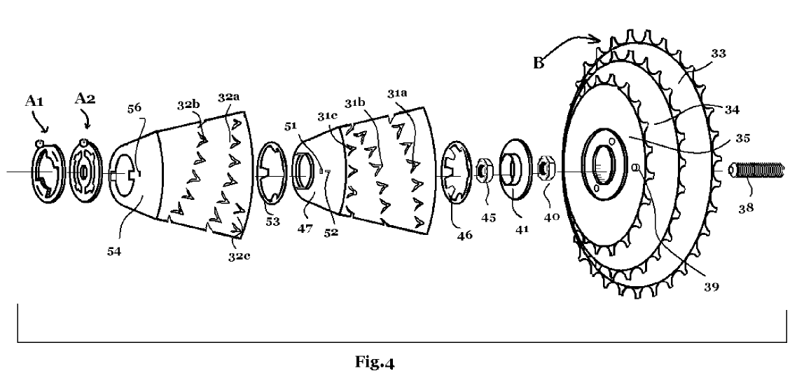

When initiating a downshift, the actuator A pushes both lifters 54 and 47 towards sprocket 39, compressing spring 46, where a ridge 52 catches on a protrusion 39. Spring 53 remains compressed and both lifters, closely nestled rotate with the sprocket assembly B. In this position lifter 54 occludes lifter 47 allowing interaction only between the teeth of lifter 54 and the chain 36. A protrusion 51 on lifter 47 remains inserted in an opening 56 on lifter 54 keeping both lifters aligned. Going to FIG. 3, it can be seen how the chain 36 is guided by the row of teeth 32b from the smallest sprocket 35 to the medium sprocket 34 effecting a downshift.

There is a redundant row of teeth on each lifter. Teeth row 31c on lifter 47 serves the purpose of carrying the chain through the lifter 47 on sprocket 35 should the rider try to initiate a further (inexistent) up shift. Similarly, teeth row 32c on lifter 54 serves the purpose of carrying the chain through the lifter 54 on sprocket 33 should the rider try to initiate a further (inexistent) downshift.

FIG. 9 illustrates the detailed construction of the second preferred embodiment. All the elements of this preferred embodiment are the same except for the chain lifters. In the first embodiment the side displacement of the chain occurs gradually, with the chain meshing with the appropriately beveled teeth. In the second embodiment, the side displacement of the chain is effected by bridge structures mounted on radial arms.

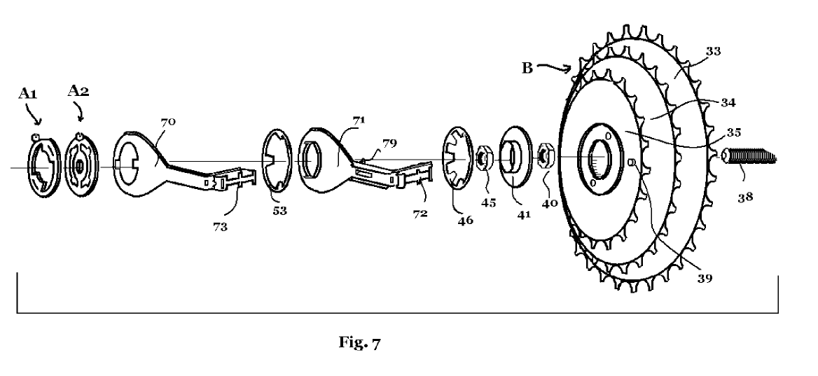

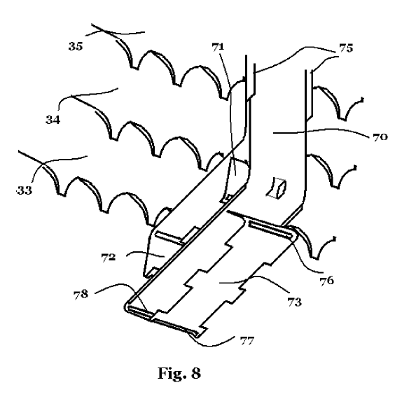

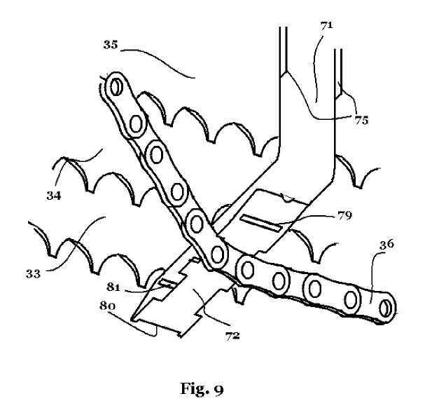

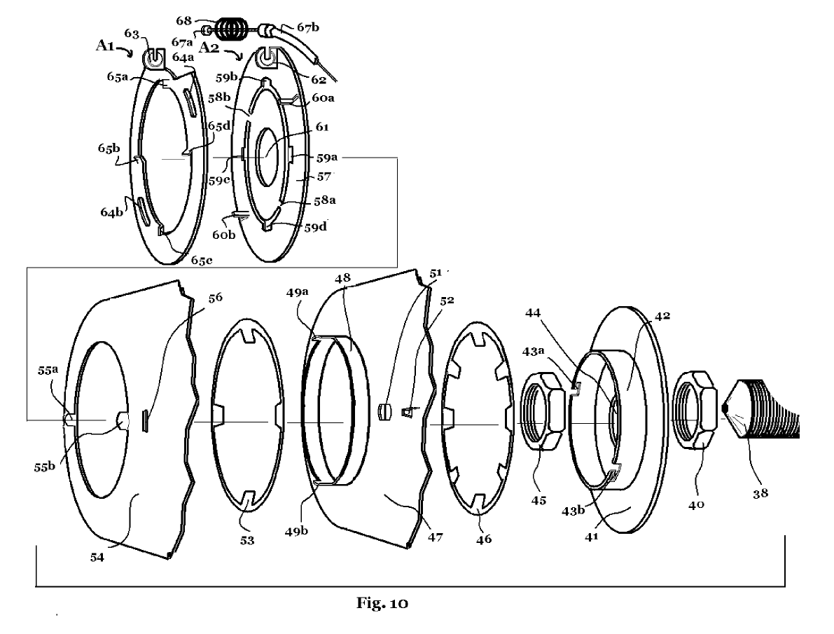

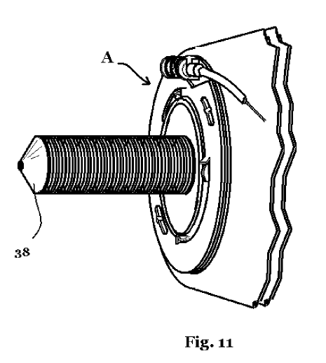

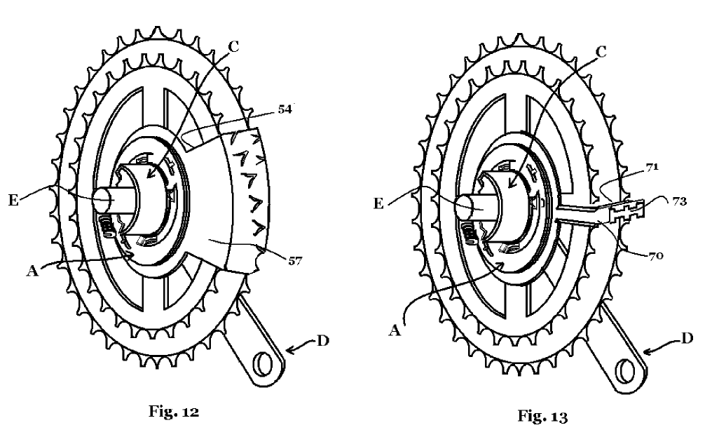

The shape and function of these bridges is better illustrated on FIG. 10 and FIG. 12. Looking at FIG. 10, the two bridges 72 and 73 can be seen in superimposed inactive position. As one possible execution of this embodiment the lifters are single pieces of flat spring steel stamped and bent to a shape resembling the letter L. The short portion of the L is furthermore bent to form parallelograms 72 and 73 with cutouts in the corners 76-81. These cutouts weaken the corners allowing the parallelograms to collapse under pressure. The arms of the lifters and the bases of the parallelograms are stiffened by forming ridges or creases. Slots are cut in the upper surfaces of the parallelograms, designed to engage the chain laterally. One of the parallelograms is slanted and collapses towards a larger sprocket (downshifting), while the other is slanted and collapses towards a smaller sprocket (up shifting). FIG. 12 illustrates a phase of downshifting, where only the lower lifter 71 is active. The chain 36 is caught in one of the slots and is displaced from sprocket 35 to the plane of sprocket 34 by the collapsed parallelogram prior to meshing. The process is better seen in its entirety in FIG. 8. FIG. 7 illustrates an up shift, where both lifters move in tandem with the upper parallelogram 73 engaging the chain. Ridges 75 on lifter 71 keep lifter 72 aligned. A tooth 79 on lifter 71 meshes with the teeth of sprocket 35, entraining lifter 71.

A crucial part of the proposed invention is the actuator mechanism. It allows the selective axial movement of the lifters of both embodiments; therefore it needs to be explained in further detail. FIG. 14 is an enlarged exploded view of said actuator mechanism with the sandwiched cutout drawings of the bases of the chain lifters. The hollow axle has a base 41 and a collar 42. The base has an opening 44 through which the wheel axle 38 is passed. The base 41 rests on locknut 40 and is fastened on the other side by locknut 45. The collar 42 has bayonet cutouts 43a and 43b placed to accept locking sectors 58a and 58b on the fixed depressor A2. Spring 46, and chain lifter 47 are rotatingly mounted on collar 42. Chain lifter 47 has a collar 48 on which spring 53 and chain lifter 54 are rotatingly mounted. Fixed depressor A2 is furthermore mounted on the protruding portion of collar 42 with sectors 58a and 58b locked in the bayonet cutouts 43a and 43b. This way assembled, diaphragm spring 46 is partially relaxed, diaphragm spring 53 is fully compressed, cam 55b protrudes from slot 59a, cam 55a protrudes from slot 59c, cam 49a protrudes from slot 59b, cam 49b protrudes from slot 59a and axle 38 protrudes from opening 61. The rotating depressor A1 is mounted on fixed depressor A2 by means of locking tab 60a passing through slot 64a and locking tab 60b passing through slot 64b. The tabs are bent, holding depressor A1 loosely, so as to allow partial rotation. Finally the control cable 67a is passed through spring 68 and attached to tab 63 on the rotating depressor A1, with the cable housing 67 pushing tab 62 on depressor A2. A spring in the controller on the handlebar (not shown) holds spring 68 partially compressed. FIG. 15 shows the assembled actuator A mounted on axle 38.

In operation, when the rider pays out cable against the controller spring (not shown), spring 68 pushes tabs 62 and 63 apart, rotating counterclockwise depressor A1 relatively to depressor A2. Slanted tabs 65a and 65b depress cams 49a and 49b and move chain lifter 48 against diaphragm spring 46 proximally to sprocket 35 where tooth 52 catches on protrusion 39 entraining chain lifter 48 with the rotating sprocket cluster B. The cams remain depressed initially by depressor A2, and then by chain lifter 48 held by the chain 36. If the rider releases the controller, the slanted tabs 65a and 65c clear slots 59b and 59a allowing cams 49a and 49b to emerge and stop the rotation of chain lifter 47 in its stowed position. During the rotation of chain lifter 47, chain lifter 54 is held in its stowed position by diaphragm spring 53.

When the rider pulls the cable by means of the controller (not shown), tabs 63 and 62 are pulled closer, further compressing spring 68. The resulting clockwise rotation of depressor A1 forces slanted tabs 65b and 65c to sink cams 55a and 55b in slots 59a and 59c, pushing in tandem chain lifter 54 and 48 axially towards sprocket 39. Tooth 52 catches on protrusion 39 on sprocket 35 and the previously described cycle is repeated, this time with the superimposed chain lifter 54 engaging the chain 36.

The proposed invention is particularly suitable for implementation as a front derailleur. All components have the same design and function as the rear derailleur with the only differences being the size and the attachment point of the hollow axle. FIG. 12 and FIG. 13 illustrate the two different embodiments. A cutaway of the bottom bracket shell C of the frame carries the actuator and the hollow axle A. The right crank D is seen attached to the spindle E.

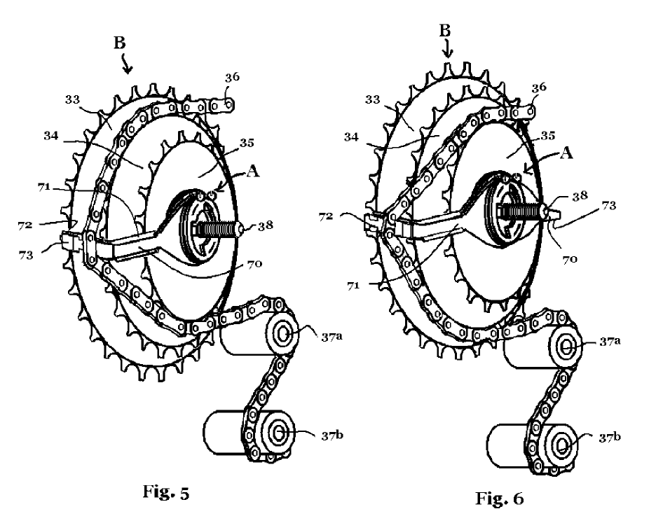

FIG. 2-3 and FIG. 5-6 also show marginally the chain tensioner. For the purpose of this invention, a simple chain tensioner with 2 rollers 37a and 37b has been chosen. The rollers allow the chain to move laterally following the chain positioning effected by the chain lifters. In retrofit applications of the invention, the parallelogram derailleur can be used as a chain tensioner only, after being disconnected from its control cable and return spring.

1. A shift mechanism such as for a bicycle for use in conjunction with a chain, a chain tensioning means and a chain driving or a chain driven sprocket assembly including a cluster of sprockets, said shift mechanism comprising a hollow, flanged axle mounted on the bicycle axle with the flange proximal to the sprocket cluster; at least one chain lifter rotatably mounted on said hollow axle, said chain lifter also being axially movable against a spring interposed between said chain lifter and the flange; an actuator to move the chain lifter axially towards the sprockets.

2. The shift mechanism of claim 1, wherein the actuator comprises a depressor plate fixedly mountable on the hollow axle with at least one opening positioned to accept at least one cam formed on the chain lifter and a means positioned to restrain the travel of a control cable housing; a rotatably mounted spring biased depressor plate positioned to depress said cam into the fixed depressor plate opening, having a means positioned to be coupled to a control cable and a spring tensioning said control cable.

3. The shift mechanism of claim 1, wherein the chain lifter has a substantially flat base and a radial member following the contour of the sprocket cluster, said member having chain guides, wherein the beginning of each chain guide lies in the plane of each larger sprocket and the end of each chain guide lies in the plane of each next smaller sprocket.

4. The shift mechanism of claim 3, wherein a tooth is formed on the base of the chain lifter, said tooth engaging the sprocket cluster when in proximal to the sprocket cluster position.

5. The shift mechanism of claim 4, wherein there is a second, superposed chain lifter having a substantially flat base and a radial member following the contour of the inferior chain lifter, said member having chain guides, wherein the beginning of each chain guide lies in the plane of each smaller sprocket and the end of each chain guide lies in the plane of each next larger sprocket.

6. The shift mechanism of claim 5 wherein a hollow axle with at least one cam is formed on the base of the inferior chain lifter.

7. The shift mechanism of claim 5, wherein at least one cam is formed on the base of the superior chain lifter, said cam angularly offset with respect to the cam on the inferior chain lifter.

8. The shift mechanism of claim 5, wherein a spring is interposed axially between the inferior chain lifter and the superior chain lifter, said spring being weaker than the spring interposed between the inferior chain lifter and the hollow axle flange of the actuator.

9. The shift mechanism of claim 1, wherein there are 2 overlapping chain lifters having substantially flat bases with arms extending substantially beyond the radius of the largest sprocket and having transverse chain-engaging members spanning the width of the sprocket cluster.

10. The shift mechanism of claim 9, wherein a first chain-lifting member is formed as an L-shaped arm with a collapsible parallelogram having slots positioned to engage the chain, said parallelogram oriented so as to displace the chain laterally from a larger sprocket to a smaller sprocket when collapsed under chain pressure.

11. The shift mechanism of claim 9, wherein the second chain-lifting member is formed as an L-shaped arm with a collapsible parallelogram having slots positioned to engage the chain, said parallelogram oriented so as to displace the chain laterally from a smaller sprocket to a larger sprocket when collapsed under chain pressure.
